(19) United States
(12) Patent Application Publication
(10) Pub. No.: US 2023/0297484 A1
(43) Pub. Date: Sep. 21, 2023

(54) PREDICTING TARGET APPLICATIONS

(71) Applicant: International Business Machines Corporation, Armonk, NY (US)

(72) Inventors: Namit Kabra, Hyderabad (IN); Vijay Ekambaram, Chennai (IN); Sarbajit K. Rakshit, Kolkata (IN)

(21) Appl. No.: 17/655,229

(22) Filed: Mar. 17, 2022

(51) Int. Cl. G06F 11/34; G06F 21/31; G06F 21/62; G06F 9/451

(52) U.S. Cl. CPC G06F 11/3409; G06F 21/31; G06F 21/629; G06F 9/451

(57) ABSTRACT

An approach for a computer application prediction program on a computing device to receive a user input to the computer user interface. The approach includes the computer program retrieving a status of one or more connected computer devices. The approach includes the computer program performing a contextual analysis of the user input. Furthermore, the approach includes the computer program retrieving, from a database, at least one similar user input and at least one target application for each of the at least one similar user inputs. The approach includes the computer program predicting at least one target application for the user input.

### BACKGROUND

The present invention relates generally to the field of computer data processing, and more particularly to a program to predict target applications for user inputs instructions using contextual analysis of the user inputs and a database containing the history of target applications for the previous user input instructions.

With the continuous development of electronic devices and communication technology, there is a proliferation of smart devices that are accessible to other computing devices such as mobile computing devices. Currently, numerous remotely connected smart device applications along with applications such as social media applications and messaging applications can be connected and open at one time in a mobile device. Information and instructions to perform various actions can pass between these connected devices and applications.

### SUMMARY

Embodiments of the present invention provide a computer program, a system, and a method for predicting one or more target applications for a user input on a user interface. The embodiments of the present invention include a computer application prediction program on a computing device receiving a user input to the computer user interface. Embodiments of the present invention include the computer application prediction program retrieving a status of one or more connected computer devices. Embodiments of the present invention include the computer application prediction program performing a contextual analysis of the user input. Furthermore, embodiments of the present invention include the computer application prediction program retrieving, from a database, at least one similar user input and at least one target application for each of the at least one similar user inputs and predicting at least one target application for the user input.

### BRIEF DESCRIPTION OF THE DRAWINGS

FIG. 1 is an illustration of a user interface of a mobile device with a predicted application program and a number of other computing devices with various device applications connecting to the mobile device, in accordance with at least one embodiment of the invention.

FIG. 2 depicts a functional block diagram of a computing environment suitable for the operation of the application prediction program, in accordance with at least one embodiment of the invention.

FIG. 3 is an example of a flow chart diagram depicting operational steps for a prediction module in the application prediction program, in accordance with at least one embodiment of the invention.

FIG. 4 is an example of a flow chart diagram depicting operational steps for the application prediction program, in accordance with at least one embodiment of the invention.

FIG. 5 is an example of one example of a prediction of several applications for a user text input using the application prediction program, in accordance with at least one embodiment of the invention.

FIG. 6 is a block diagram depicting components of a computer system suitable for executing the application prediction program, in accordance with at least one embodiment of the invention.

### DETAILED DESCRIPTION

Embodiments of the present invention recognize that many smart devices may be wirelessly connected by the Internet of Things (IoT). Using a computing device user interface, the user can input text or voice commands to different applications running on various connected devices. Embodiments of the present invention recognize that the user may wish to reuse the same textual input for multiple applications open on the mobile device or on multiple applications running on different connected devices. Embodiments of the present invention recognize that currently; when multiple applications are open on the computing device, the user selects the desired application and inputs the textual input or instruction on that open application. With current technology, embodiments of the present invention recognize that it is not easy for the user to apply the same textual input into more than one application at the same time for example, when the user is inputting to an application in a mobile device or smart phone. Embodiments of the present invention recognize that it would be desirable for a user to type textual inputs or input voice commands that can be applied to multiple applications at once. It would be desirable if a program on the mobile device could analyze, in real-time, the user input text and dynamically determine one or more predicted target applications for the user input text. Embodiments of the present invention recognize that an ability to predict, display, and in some cases, directly send a user's textual input to multiple predicted target applications on multiple devices at the same time would be desirable.

Embodiments of the present invention provide a method, a computer program, and a computer system that predicts target applications, in near real-time, for user text input on a home screen of a computing device and dynamically creates a display of the predicted target application for the input text. The application prediction program uses a contextual analysis of the input text, retrieved data from other connected IoT devices, information retrieved from a database storing the user's historical text inputs, and the user's previous target application selections associated with each previous user input text. The database of the user's previous inputs and target applications for each user input can be a corpus and a knowledgebase within computer storage.

Embodiments of the present invention using a contextual analysis of the user input and information retrieved from a database storing the user's previous inputs to a user interface of a computing device and the applications to which each of the previous user inputs are directed to, the application prediction program predicts one or more target applications associated with a current user input and displays predicted target applications for the current user input. The application prediction program can receive a user selection of one or more of the displayed predicted target applications and sends the user's input to each of the selected predicted target applications. The predicted target applications can be on one or more connected computing devices.

Embodiments of the present invention provide the application prediction program that can retrieve, from storage, previous authorization credentials to some or each of the applications on the connected devices. The application prediction program can send the user's input, the contextual analysis of the user's input, the predicted target applications, and the user selection of one or more of the predicted target applications for the user's input to a database storing the previous user inputs and previous target applications for each user input.

Embodiments of the present invention provide the application prediction program that can automatically select one or more of the predicted applications to send the text or instructions to for execution based, at least in part, on matches of the current user input to previous user inputs that have been retrieved from the database storing the user input history. Embodiments of the present invention disclose that the user input is automatically sent to one or more predicted target applications by the application prediction program when the target application for each of the matching previous user inputs was directed to the same target application. Embodiments of the present invention also provide an application prediction program that can dynamically display, as the user is inputting the instructions on the user interface of the computing device (e.g., a mobile device), one or more of the predicted target applications for selection by the user as the target application for the user input instructions.

Embodiments of the present invention upon receiving the user selection of one or more of the predicted target applications, the application prediction program sends the user input instructions to each of the user selected applications. In this way, embodiments of the present invention provide a method and a program to predict and simultaneously send to a number of target applications the same instruction or user input with only a single entry of the user input to the user interface of the user's computing device.

The present invention will now be described in detail with reference to the Figures. Implementation of embodiments of the invention may take a variety of forms, and exemplary implementation details are discussed subsequently with reference to the Figures. Many modifications to the depicted environment may be made by those skilled in the art without departing from the scope of the invention as recited by the claims. For the purposes of the present invention, the terms “application” and “app. ” are used interchangeably to describe an application program or application software, that is a computer software package. As known to one skilled in the art, an application or app. performs a specific function directly for an end user based on a user input to a computer user interface or, in some cases, for another application. An application can be self-contained or a group of programs.

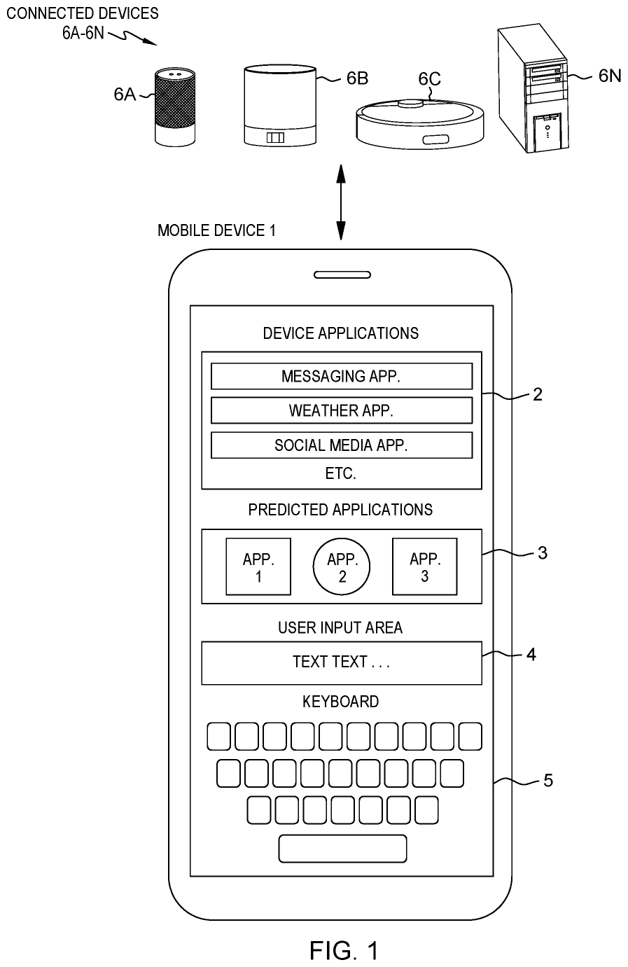

FIG. 1 is an illustration of a user interface of mobile device 1 that is connected to multiple other the Internet of Things (IoT) devices 6A-N, in accordance with at least one embodiment of the invention. FIG. 1 is an illustration of one example a user interface for mobile device 1 and an example of some of the computing devices that mobile device 1 may be connected to. As depicted, FIG. 1 includes an example of a user interface of mobile device 1 that is displaying device applications 2, predicted applications area 3, user input area 4, and keyboard 5 where mobile device 1 is connected to IoT devices 6A-N.

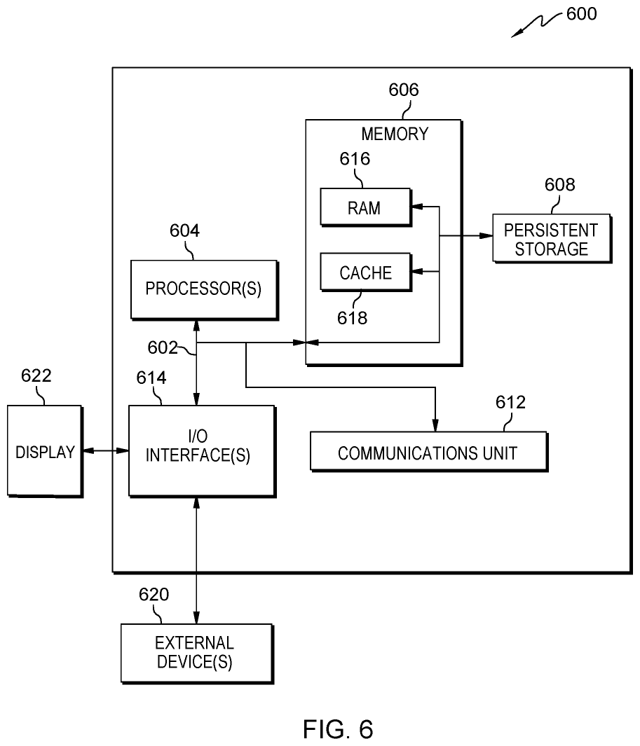

Mobile device 1 can be any computing device as discussed later as computing system 600 with respect to FIG. 6. As depicted in FIG. 1, mobile device 1 is a smart phone. Device applications 2 can be any smart phone application such as messaging applications, social media applications, navigation applications, calendar applications, etc. that are available for mobile devices.

In FIG. 1, IoT devices 6A-N include digital assistant 6A, wireless speaker 6B, robotic vacuum 6C, and computer 6N. In other examples not depicted in FIG. 1, mobile device 1 may be connected to any number of IoT devices, such as but not limited to a smart home system, a vehicle computing system, a business computer system with various business device applications, any number of social media applications, and any number of computing devices (e.g., smart watch, tablets, laptop computers, smart home computer, etc.). In various embodiments, mobile device 1 identifies the other computing devices and applications connected to mobile device 1.

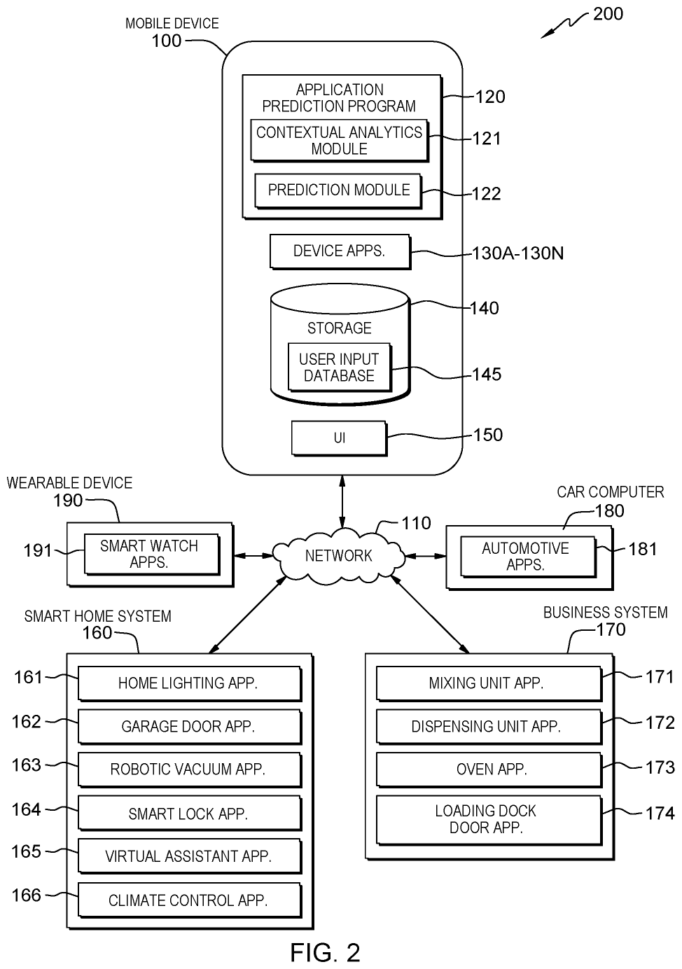

Mobile device 1 can share information and data over a network connection such as network 110 depicted in FIG. 2. Using the application prediction program (not depicted in FIG. 1) on mobile device 1, mobile device 1 performs a contextual analysis of the input text in user input area 4, retrieves information and connection data from the data feeds of IoT devices 6A-N, and retrieves associated historical user inputs with the user selected target applications for each user input from a database (not depicted in FIG. 1) in order to predict likely target applications of the text the user is typing in user input area 4. As the application prediction program on mobile device 1 determines likely target applications for the text the user is currently inputting in user input area 4 of the user interface of mobile device 1, the application prediction program, in real-time or near real-time, creates a display in predicted application area 3 of the most likely target applications for the user input being typed in user input area 2. As the user is typing in the inputs or instructions, the application prediction program determines and dynamically displays the predicted target applications (e.g., represented by icons) to the user in predicted applications 3 of mobile device 1 user interface. The number of predicted target applications and each of the predicted target applications displayed may change as the user continues to input text into user input area 4.

In various embodiments, upon receiving a user selection of one or more of the predicted applications in predicted applications area 3, the application prediction program on mobile device 1 sends the user input text or instructions to the associated device application 2 and/or to one or more of IoT devices 6A-N and the associated IoT device applications (not depicted in FIG. 1). The application prediction program also sends the user input in user input area 4 and the selected target applications from predicted application area 3 to one of or both of a storage location in mobile device 1 (not depicted) or storage in a remote database, for example, in a server or the cloud. In some embodiments, the application prediction program sends the user input directly to the predicted applications based, at least in part, on retrieved data on the user's previous user inputs and targeted applications for the previous user inputs that match the current user input.

FIG. 2 depicts a functional block diagram of a computing environment 200 suitable for the operation of application prediction program 120, in accordance with at least one embodiment of the invention. As depicted, FIG. 2, includes mobile device 100 with application prediction program 120, device apps. 130A-130N, storage 140 with user input database 145, user interface (UI) 150, wearable device 190, car computer 180, business system 170, and smart home system 160 that are connected over network 110. FIG. 2 is one example of computing environment 200 where application prediction program 120 resides on mobile device 100 and mobile device 100 is connected by network 110 to any number of other computing devices with various device applications.

In embodiments of the present invention, network 110 can be a telecommunications network, a local area network (LAN), a wide area network (WAN), such as the Internet, or a combination of the three, and can include wired, wireless, or fiber-optic connections. Network 110 may include one or more wired and/or wireless networks that are capable of receiving and transmitting data, voice, and/or video signals, including multimedia signals that include voice, data, and video formation. In general, network 110 may be any combination of connections and protocols that will support communications between mobile device 100, smart home system 160, business system 170, car computer 180, wearable device 190, and other computing devices (not shown) within computing environment 200.

Mobile device 100 is a computing device that can be a smartphone, a laptop a computer, a tablet computer, a netbook computer, a personal computer (PC), a desktop computer, a personal digital assistant (PDA), smartwatch, or any programmable electronic device capable of receiving, sending, and processing data. Mobile device 100 can have the attributes and elements of computer system 600 as described in detail with respect to FIG. 6. In other embodiments, mobile device 100 represents a server computing system utilizing multiple computers as a server system, such as in a cloud computing environment. In an embodiment, mobile device 100 represents a computing system utilizing clustered computers and components (e.g., database server computers, application server computers, web servers, and media servers) that act as a single pool of seamless resources when accessed within computing environment 200. In general, mobile device 100 represents any programmable electronic devices or combination of programmable electronic devices capable of executing machine readable program instructions and communicating with other computing devices (not shown) within computing environment 200 via a network, such as network 110.

In various embodiments, application prediction program 120 resides on mobile device 100. Application prediction program 120 can receive, send, or retrieve data from any IoT connected computing devices such as wearable device 190, car computer 180, business system 170, smart home system 160, any computing device applications associated with a connected device. Additionally, application prediction program can retrieve from user input database 145, previous user inputs and the associated target applications for each of the previous user inputs. In some embodiments, application prediction program 120 may retrieve data from a database with a corpus and a knowledgebase residing in a service provider server or residing in a cloud-based storage environment. In an embodiment, application prediction program 120 resides on a server such as a service provider server (not depicted in FIG. 2) or another computer (not depicted) residing in the cloud.

In various embodiments, application prediction program 120 identifies, through paired IoT device real-time feeds, if the user is issuing a voice command or input to another nearby or adjacent device. For example, application prediction program 120 receives from an IoT feed an indication that a nearby wireless speaker has been turned on, for example by a voice command to a virtual assistant. Application prediction program 120 retrieves previous user input or instruction history associated with the wireless speaker from user input database 145. Based, at least in part, on the user's previous application selections associated to the wireless speaker application, application prediction program 120 can display, on UI 150, the radio station applications and/or music service applications most commonly requested by the user. Upon determining a user selection of music service X, application prediction program 120 using the retrieved data on the previous user musical selections, determines that due to a significant number of previous user inputs selecting “John Smith playlist” in music service X, application prediction program 120 begins to execute the “John Smith playlist” and displays the predicted playlist along with two other of the most commonly selected playlists by the user in music service X. The user may allow the execution of “John Smith playlist,” the user may input another playlist, or the user may select one of the other two playlists displayed by application prediction program 120 to the user in the predicted application area of UI 150.

In some embodiments, application prediction program 120 determines that the current user input matches several of the retrieved, previous user inputs and determines that each of the matching previous user inputs are directed to the same applications by the user, then application prediction program 120 sends the current user input to applications associated to the previous user inputs matching the current user input (e.g., that are the same as the current user input). In these cases, application prediction program 120 sends the user input to the determined target application while displaying in UI 150 to the determined target application. Application prediction program 120 also sends the user input and the user selected predicted target applications to user input database 145 in storage 140.

Contextual analytics module 121 in application prediction program 120 analyzes the user input or text, in real-time, to determine the content and context of the user input in UI 150. Contextual analysis module 121 provides contextual analysis of the user input text as the user is inputting the text. Contextual module 121 uses natural language processing (NLP) to provide semantic understanding of the user input text.

Contextual analytics module 121 can use various NLP methods including dependency extraction and co-reference resolution. For example, contextual analysis module 121 may use techniques such as neural network-based coreference resolution for the clustering of mentions referring to the same underlying entities. Contextual analysis module 121 may also use dependency parsing to analyze the grammatical structure in a sentence and to identify related words as well as the type of the relationship between them. Contextual analysis module 121 may also use Named-Entity Recognition (NER). NER is also known as entity identification, entity chunking, and entity extraction and NER can be a subtask of information extraction. NER seeks to locate and classify named entities mentioned in unstructured text into pre-defined categories such as person names, organizations, locations, etc. Contextual analysis module 121 is not limited to these methods of NLP for contextual analysis of the user input text and also use other known NLP techniques. For example, application prediction program 120 may also utilize word embedding is a term used for the representation of words for text analysis in the form of a real-valued vector in an n-dimensional vector space that encodes the meaning of the word such that the words that are closer in the vector space are expected to be similar in meaning.

In various embodiments, application prediction program 120 includes prediction module 122. Prediction module 122 using the contextual analysis retrieved from contextual module 121 and data on previous user inputs and associated application selections from user input database 145 in storage 140, prediction module 122 in application prediction program 120 dynamically predicts one or more target applications for the user input. Prediction module 122 retrieves from contextual analysis module 121. In some cases, prediction module 122, uses the contextual analysis to determine the user's intent and possible target applications. Prediction module 122 retrieves information on the previous applications for previous user inputs that are similar or the same as the current user input to UI 150. The data on the user's previous unput and application history can be extracted by the program from user input database 145 on similar previous user inputs and target applications, prediction module 122.

User input database 145 in storage 140 includes a knowledge-based corpus of previous user inputs and associated applications for each input that uses known knowledge-based algorithms. User input database 145 can include the contextual analysis of each of the previous user inputs provided by contextual analysis module 121 in some embodiments.

Application prediction program 120 in real-time, predicts target applications as the user is typing inputs into UI 150 and dynamically displays the currently predicted applications on UI 150 to the user. The predicted applications determined by application prediction program 120 may change as more input is provided or typed by the user (e.g., there may be less displayed predicted target applications, more predicted target applications, or different predicted applications). In addition to displaying the predicted target applications, application prediction program 120 identifies the user's level of authentication to submit commands to different devices and, accordingly, based on an appropriate level of user authentication and permission of the user, the associated application icon can be displayed to the user on UI 150. In various embodiments, application prediction program 120 cross-certifies the user for predicted applications and sends the user input or instructions to user selected displayed applications on UI 150.

In various embodiments, device apps. 130A-130N are applications embedded, downloaded, or uploaded in mobile device 100. As known to one skilled in the art, device apps. 130A-130N can be any smart phone application provided by the mobile device manufacturer or added to mobile device 100 by the user. For example, device apps. 130A-130N can include but are not limited to social media applications, global position system (GPS) applications, e-mail applications, weather applications, music applications, smart home device applications, etc. In various embodiments, application prediction program 120 includes previous application authorizations (e.g., specific application user identification, passwords, passcodes, etc.) for some or all of device apps. 130A-130N. In various embodiments, application prediction program 120 can provide cross-certification to the applications and/or to other suitable connected devices with the previously authorized application. Application prediction program 120 in mobile device 100 can access any application on a connected computing device (e.g., a climate control app. in a smart home system or a locking dock door application in a connected business computer system).

In various embodiments, storage 140 resides on mobile device 100. Storage 140 can be any type of computer storage and/or database. As depicted in FIG. 2, storage 140 on mobile device 100 includes user input database 145. User input database 145 contains a corpus for knowledge-based storage of the user's previously input text on mobile device 100 and the application(s) to which the input was directed. User input database 145 can be accessed and used by prediction module 122 in application prediction program 120 to aide in the determination of the predicted target applications for each of the user's real-time or current inputs.

Mobile device 100 includes UI 150. A user interface such as UI 150, is a program that provides an interface between a user and an application. A user interface refers to the information (such as graphic, text, and sound) a program presents to a user and the control sequences the user employs to control the program. There are many types of user interfaces. In one embodiment, a user interface may be a graphical user interface (GUI). A GUI is a type of user interface that allows users to interact with electronic devices, such as a keyboard and mouse or a touch screen through graphical icons and visual indicators, such as secondary notations, as opposed to text-based interfaces, typed command labels, or text navigation. Application prediction program 120 creates a display area to provide the predicted target applications (e.g., each predicted application displayed as a user selectable icon). In various embodiments, on UI 150, application prediction program 120 receives the user selection of one or more of the displayed predicted target applications for the current user input and sends the user input to each of the user selected target applications.

Smart home system 160 with home lighting app. 161, garage door app. 162, robotic vacuum app. 163, smart lock 164, virtual assistant app, 165, and climate control app. 166 connects to application prediction program 120 on mobile device 100 over network 110 in FIG. 2. Smart home system 160 is any type of available home control program and/or system connecting to any number of home computerized devices and applications such as a home lighting app. 161 that can provide and execute instructions to one or more lights or lighting fixtures in or outside of a home that is using smart home system 160. As known to one skilled in the art, smart home system 160 may be connected to any number of devices and applications (e.g., home lighting app. 161, garage door app. 162, etc.). Smart home system 160 can include any available smart home device and application. In various embodiments, smart home system 160 directs any user input instructions on UI 150 of mobile device 100 to the user selected predicted application displayed to the user by application prediction program 120. In some embodiments, application prediction program 120 determines which of the predicted target applications is to receive the instructions input by the user on UI 150 and sends the instructions to the predicted target application(s) determined by application prediction program 120. In some embodiments, application prediction program 120 includes previously used authorizations such as user identification and passwords or other type of authorization in prediction module 122 or retrieves the previously used authorizations from user input database 145 in storage 140 for some or all of the applications depicted in smart home system 160. In some cases, application prediction program 120 may provide cross-certification between the applications in smart home system 160, for example, in order to execute the instructions. In an embodiment, application prediction program 120 provides cross-certification between one or more of the applications depicted in FIG. 2.

Business system 170 can be any computing device or devices connected to application prediction program 120 over network 110. As depicted, business system 170 includes mixing unit app. 171, connected mixing equipment (not depicted), dispensing unit app. 172, oven app. 173 connected to one or more ovens (not depicted), loading dock door app. 174 connected to dock door lifts (not depicted). As depicted, business system 170 is one example of a business system connected to application prediction program 120 over network 110 but a business system in other examples may have other devices and device apps. In some embodiments, business system 170 receives from application prediction program 120 instructions for oven app. 173 to increase the oven temperature to 300 degrees Celsius and in response, business system 170 sends the instructions over to app. 173 controlling the oven temperature. Oven app. increases the oven temperature to 300 degrees Celsius. Business system 170 can receive user input instructions from application prediction program 120 on mobile device 100 for any of the applications connected to business system 170 and send the instructions to one or more applications identified by application prediction program 120 (e.g., the predicted applications selected by the user on UI 150 of mobile device 100).

Car computer 180 can be an integrated computer automotive system connected with application prediction program 120 on mobile device 100 over network 110. As depicted, car computer 180 includes various automotive apps. 181 (e.g., music system app. that automatically connects with a user's smart phone and favorite music app.). As known to one skilled in the art, car computer 180 can connect over network 110 with any of the computing devices depicted in FIG. 2. For example, car computer 180 can receive a car passenger generated input on mobile device 100 to navigate to home or another input destination. In response, car computer 180 receives the instructions and sends the instructions to the on-board navigation system (not depicted). The on-board navigation system calculates the route to the input destination and displays the route to the driver using the dashboard display (not depicted).

Wearable device 190 can be any type of wearable device, such as a smart watch, connected to mobile device 100 and application prediction program 120 over network 110. In some embodiments, wearable device 190 receives spoken user input that is translated into textual input and sent to application prediction program 120 on mobile device 100. Application prediction program 120 analyzes the contextual content and associates the received user input to previous user inputs retrieved from user input database 145 to determine the most likely or predicted target applications. Application prediction program 120 displays to the user the predicted target applications and based on the user selection of the predicted target application, sends the instructions to the selected application as previously discussed.

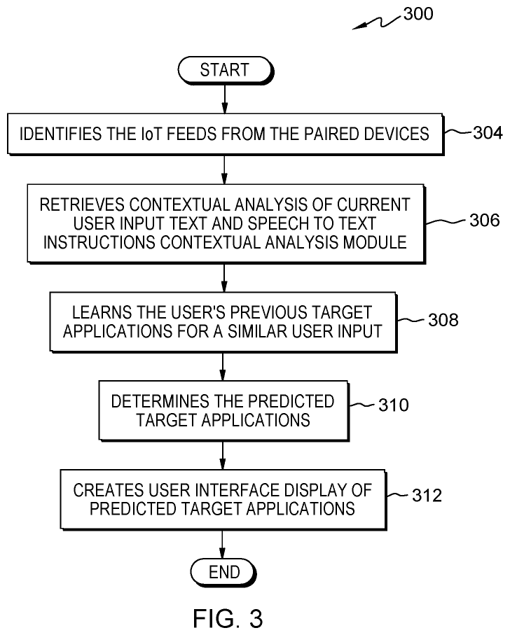

FIG. 3 is an example of a flow chart diagram 300 depicting operational steps for application prediction program 120 using prediction module 122, in accordance with at least one embodiment of the invention. FIG. 3 illustrates one example of the operational steps of prediction module 122 in application prediction program 120.

In step 304, using prediction module 122, application prediction program 120 identifies IoT feeds from the connected devices. For example, using prediction module 122, as depicted in FIG. 2, application prediction program 120, using known connection determination techniques, determines that a smart home system, such as smart home system 170 with smart lock app. 164 is connected over network 110 to application prediction program 120 on mobile device 100. In some embodiments, the identifying by application prediction program 120 includes retrieving previous authorizations to smart lock app. 164, for example from mobile device storage. In various embodiments, application prediction program 120 determines each of the connected or paired applications and the status of the application. The applications can each reside on one or more connected devices or can reside on the computing device containing application prediction program 120 (e.g., mobile device 100 depicted in FIG. 2). In some cases, application prediction program 120 generates a cross-authorization to some or all of the connected applications identified by application prediction program 120, based at least in part, on previous authorizations retrieved from storage 140 on mobile device 100.

In step 306, application prediction program 120 using prediction module 122 retrieves the contextual analysis of the current user input text. For example, the user inputs text or voice commands to UI 150 on mobile device 100 (depicted in FIG. 2), and as previously discussed, contextual analysis module 121 depicted in FIG. 2, analyzes the user input text using one or more NLP approaches such as but not limited to sentence embedding or word clustering. Application prediction program 120 uses the contextual analysis output to determine the user's intent of the input. In various embodiments, determining the user's intent by application prediction program 120 includes determining a likely target application for the user input text or instructions. In some cases, based on the contextual analysis, application prediction program 120 determines one or more potential target applications for the user input.

In step 308, application prediction program 120 learns the user's previous selected applications for a similar or the same user input based, at least in part, on retrieving from a database, the user's previous inputs and previous target applications associated with each of the user's previous inputs. Using user input database 145 depicted in FIG. 2 with knowledge-based algorithms to search the corpus of stored previous user inputs and previous target applications associated with each previous user input, application prediction program 120 determines similar or the same previous user inputs and retrieves the user target applications and target devices for the similar previous user inputs.

In step 310, application prediction program 120 using prediction module 122, determines the predicted target applications. Using the user's previous selected applications for the same or a similar user input as determined in step 308 and the retrieved contextual analysis of the current user input, application prediction program 120 can predict one or more target applications for the current user input. For example, application prediction program 120 can predict one or more target applications on one or more computing devices by using a solution to a simple machine learning classification problem where the user input text can be converted into a set of features. As known to one skilled in the art, the features can be in one or multiple forms such as word embeddings, sentence embeddings, and/or dependency graph and co-reference graph features which can be classified using machine learning. In various embodiments, application prediction program 120 filters the list of potential target applications based on the surrounding device context. For example, while a user is typing any textual content on the home-screen keyboard of a mobile device, application prediction program 120 will be predicting the target applications for which the user is typing the text (for example, for a command to a smart washing machine, the washing machine control app. will be predicted as the target application), and accordingly the predicted target application icon will be displayed around the textual content that is being written. The application prediction program 120 will be analyzing the contextual sense of the content that is being written, the IoT feed from the surrounding devices, and accordingly by identifying target applications and devices where the textual content is targeted to. In various embodiments, application prediction program 120 will be creating an appropriate user interface dynamically. Additionally, based on the identification of the target device, application prediction program 120 connects to surrounding devices to identify if the content is being written is targeted to any external device and display the icons of those device applications in the user interface along with the textual content being written.

In step 312, application prediction program 120 creates a user interface display of the predicted target applications. Application prediction program 120 dynamically displays the predicted target applications to the user, for example, as an icon depicting each of the predicted target applications in an area of the mobile device's user interface. In various embodiments, application prediction program 120 autoloads each of the predicted target applications. As previously discussed, in various embodiments, application prediction program 120 determines the user's level of authorization for each of the predicted target application. When the user's level of authorization is appropriate, application prediction program 120 retrieves, for example from storage, the user authorization credentials, and provides the authorization or cross-authorization credentials to the associated predicted target applications and/or the devices associated with the predicted target applications. In various embodiments, application prediction program 120 displays only the predicted target applications that the user is authorized to access. In some embodiments, when application prediction program 120 determines that the user does not have the appropriate level of authorization to access one or more of the predicted target applications (e.g., when an authorization has expired or lapsed), the target applications the user is not authorized to access are not displayed to the user as a target application for the current user input.

During the autoloading of the current user input, application prediction program 120 copies the current user input into each of the predicted target applications. In this way, the user provides one user input or instruction to UI 150 of mobile device 100 (depicted in FIG. 2), and the user input can be automatically provided by application prediction program 120 to multiple applications on one or more computing devices. For example, a user input such as “send to medical school friend group” associated with a photograph may be predicted by application prediction program 120 to be posted on two social media applications based, at least in part, on the previous user history retrieved from user input database 145 (depicted in FIG. 2). In various embodiments, using the contextual analysis of the user input and the previous user's history retrieved from user input database 145, application prediction program 120 determines several social media applications as probable target applications for the current user input. Application prediction program 120 can display the probable social media applications to the user for selection.

In some embodiments, when the user input and/or the user instructions are the same as of the user's previous inputs and when the same target application is used for each of the matching previous user inputs, then application prediction program 120 may execute the current user input on the previous application(s) of the matching previous user inputs. Application prediction program 120 can display the previous application(s) executed for the current user input to the user.

In various embodiments, after determining the predicted applications for the current user input and loading the user input to each of the predicted target applications, prediction module 122 in application prediction program 120 ends.

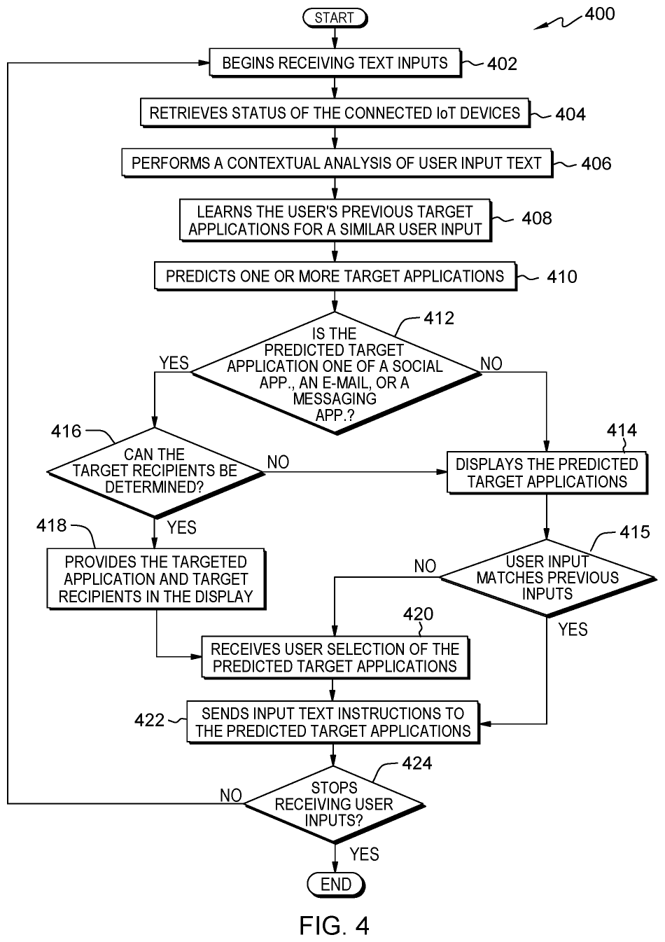

FIG. 4 is an example of a flow chart diagram 400 depicting operational steps for application prediction program 120, in accordance with at least one embodiment of the invention. As previously discussed in detail with respect to FIG. 2, application prediction program 120 resides on a computer, such as mobile device 100 in a computer environment 200. While the steps of FIG. 4 are discussed with respect to user input written text, the user input could be a spoken or voice input.

In step 402, application prediction program 120 begins receiving text inputs on a computing device user interface. For example, the user of a mobile device opens the keyboard from the home screen and starts typing. In some cases, the user may begin typing the input to an open application.

In step 404, application prediction program 120 retrieves information on the status of the connected IoT devices. The status of the connected IoT devices can include the number of connected IoT devices, a connection status of each device, the applications currently open on each IoT device, any applications currently executing on the device, etc. In various embodiments, application prediction program 120 identifies each of the applications and computing devices the user is accessing and can access, what types of commands can be submitted by the user of the mobile device or computing device receiving the user input. Application prediction program 120 retrieves from a database, such as user input database 145 depicted in FIG. 4, previous user authorizations (e.g., passwords, user identification, etc.) and can in some incidences, provide cross-authorization across some or all of the applications on the connected IoT devices as previously discussed.

In step 406, application prediction program 120 performs a contextual analysis of the user input text. As previously discussed in detail with respect to FIG. 2, using a contextual analysis method such as performed by contextual analysis module 121 described with respect to FIG. 2, application prediction program 120 uses various NLP techniques to analyze the user input text as it is being written. In various embodiments, application prediction program 120 identifies the open applications in the computing device (e.g., mobile device 100 in FIG. 2) and determining if the user input text is written for one of the open applications. Based, at least in part, on the contextual analysis of the user input text, application prediction program 120 may determine which of the IoT connected devices and which of the IoT device applications the user input is targeted to.

In step 408, application prediction program 120 retrieves previous target applications associated with similar user inputs from a user database of previous user inputs and the target applications associated with each previous user input. For example, application prediction program 120 retrieves from user input database 145 in storage 140 of mobile device 100 depicted in FIG. 2. As previously discussed, the database can contain a corpus of the previous user inputs where the database (e.g., user input database 145) can be evaluated using one or both of a corpus-based or a knowledge-based analysis of the previous user inputs. As known to one skilled in the art, the corpus-based and/or the knowledge-based analysis can be used to identify or match previous user inputs to current user inputs. In various embodiments, using the retrieved information from the database of the user's previous inputs and target applications for each previous user input, application prediction program 120 can determine the user's intent and intended target applications for the stored previous user inputs to a current user input.

In step 410, application prediction program 120 predicts one or more target applications. As previously discussed, based, at least in part, on the previous user history retrieved from a database (e.g., user input database 145 in FIG. 2) and user input contextual analysis, application prediction program 120 predicts one or several target applications for the user input or instructions being typed into a user interface. For example, application prediction program 120 uses the retrieved contextual analysis of the user input, the status of the various applications on the connected devices, and the previous user input history with the previous user target applications for each user input to predict the most likely target application for the user's current text input. In some cases, application prediction program 120 filters possible target applications based, at least in part, on the status of the connected IoT devices. For example, based on the retrieved status of the IoT devices in step 404, application prediction program 120 determines a climate control application (e.g., climate control app. 166 in FIG. 2) is operating but is not activating the air conditioner, upon receiving a user input to reduce the house temperature, application prediction program 120 determines the climate control application is the predicted target application.

In decision step 412, application prediction program 120 determines whether the predicted target applications are one of a social application, an e-mail application, or a messaging application, for example, on the mobile device receiving the user input.

Responsive to determining that the predicted target applications are not one of a social application, an e-mail application, or a messaging application, for example, on the mobile device receiving the user input (no branch of decision step 412), then in step 414, application prediction program 120 displays the predicted target application to the user. The predicted target applications may each be displayed as a user selectable icon in the user interface by application prediction program 120. As previously discussed in FIG. 3 with respect to prediction module 122, in various embodiments, application prediction program 120 displays only the predicted target applications that the user is authorized to access. In some embodiments, when application prediction program 120 determines that the user does not have the appropriate level of authorization for one or more of the predicted target applications (e.g., when an authorization has expired or lapsed), the target applications the user is not authorized for are not displayed to the user as a target application for the current user input. In these cases, application prediction program 120 prevents the display of the predicted target applications that the user does not have access to (e.g., does not have the necessary level of authorization, approval, or certification to access).

In decision step 415, application prediction program 120 determines whether the user input matches previous user inputs. Using the retrieved previous user inputs, application prediction program 120 identifies whether a number of matching previous user inputs are retrieved from the database of the user's previous inputs and associated applications (e.g., user input database 145 in FIG. 2). In some embodiments, step 415 occurs before step 414.

Responsive to determining that the user input matches a number of previous user inputs (yes branch of decision step 415) and application prediction program 120 determines that the same target applications were used for each of the matching user inputs, then in step 422, application prediction program 120 sends the user input text to the previously targeted applications as the predicted target applications. In this case, application prediction program 120 may flash the displayed predicted target application or otherwise highlight the application to inform the user that the input text or instruction routed to the highlighted application for execution.

Responsive to determining that the user input does not match several of the previous user inputs (no branch of decision step 415), then in step 420, application prediction program 120 receives the user selection of one or more of the predicted target applications.

Responsive to determining that the predicted target application is one or more of a social application, an e-mail, or a messaging application (yes branch of decision step 412), then application prediction program 120 determines whether the target recipients can be determined in step 416.

Responsive to determining that the targeted recipients cannot be determined (no branch of decision step 416), then application prediction program 120 displays the predicted target applications to the user in step 414. For example, as depicted in FIG. 1, application prediction program 120 in step 416, displays icons in predicted application area 4 associated with each of the predicted applications.

Responsive to determining that the predicted target recipients can be determined (yes branch of decision step 416), then in step 418, application prediction program 120 provides the targeted application and the target recipients in the mobile device user interface to display to the user. Using the contextual analysis and the analysis of the user's previous input instructions (e.g., similar user inputs with the associated target application retrieved from a database of the user's previous inputs and target applications), in some cases, application prediction program 120 can identify matching previous user inputs with the same target applications that provided the same instructions or the same recipients. For example, using the user input database 145 depicted in FIG. 2, application prediction program 120 retrieves user inputs matching the current user input. In this case, application prediction program 120 determines that several user inputs of “please renew my QAZ prescription” were each previously sent as an e-mail to pharmacy XYZ. In this case, application prediction program 120 identifies the predicted application to be the e-mail application and the predicted recipient to be “pharmacy XYZ.” Application prediction program 120 determines in response to the retrieved identical user inputs, the target application (e.g., e-mail application), and the user intended recipient (pharmacy XYZ). In this case, application prediction program 120 may send the e-mail to pharmacy XYZ and display the predicted application and recipient to the user.

In step 420, application prediction program 120 receives the user selection of the predicted target applications. The user may select one or more of the predicted target applications displayed in the user interface (e.g., one or more icons selected in predicted application area 4 of FIG. 1). In some cases, for example, when the user selected predicted applications are social media applications, a selection or addition of recipients may be needed. In these cases, the user inputs additional information (e.g., desired recipients).

In step 422, application prediction program 120 sends the user input the predicted target applications. In various embodiments, the predicted target applications are determined by application prediction program 120 based on matching previous user inputs and matching previous target applications associated with the previous user input (e.g., as determined in decision step 415). In other embodiments, the predicted target applications receiving the user input is based on the user selection of one or more predicted target applications in step 420. For example, upon application prediction program 120 receiving the user selection of the two icons associated with social media application A and social media application B of the displayed predicted applications, application prediction program 120 sends a photograph to social media application A and social media application B.

In step 424, application prediction program 120 determines whether the program stops receiving user inputs.

Responsive to receiving another user input (yes branch of decision step 424), application prediction program 120 returns to step 402 to determine the predicted applications for the new user input.

Responsive to determining that the user input is complete and application prediction program 120 stops receiving user inputs (no branch of decision step 424), then application prediction program 120 ends.

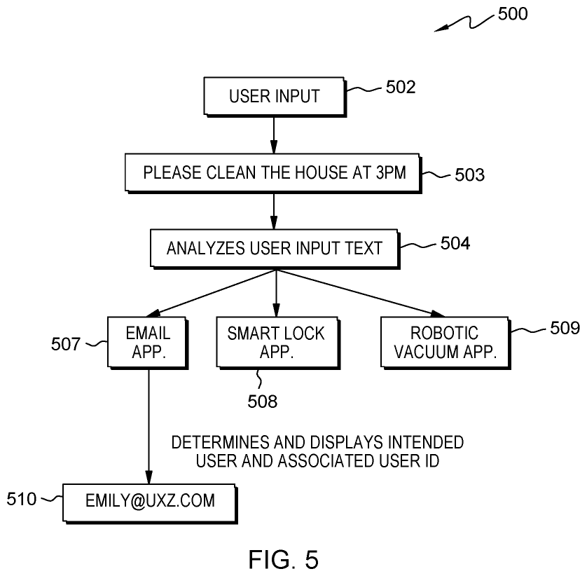

FIG. 5 is one example of a prediction of several applications for a user text input using the predicted application program, in accordance with at least one embodiment of the invention. FIG. 5 illustrates one potential user input to a computing device such as a mobile device and some of the potential predicted applications determined by application prediction program 120 depicted in FIG. 2.

For example, mobile device (e.g., mobile device 100 in FIG. 2) receives user input 502. As previously discussed in various embodiments, user input 502 is typed into the user interface of the mobile device that is running the application prediction program. As depicted, the user input 502 is “please clean the house at 3 pm.” In some cases, the user input 502 is spoken. Using the methods discussed in detail above in FIGS. 3 and 4, application prediction program 120 analyzes the input text (e.g., please clean the house at 3 pm). The analysis includes retrieving data from a user input database on previous similar user inputs (e.g., please clean the house) and associated target applications associated with this previous user input. Application prediction program 120 determines the predicted target application from the contextual analysis and the analysis of the user's historical data on target applications associated with a user input of “please clean the house.” The application prediction program displays the predicted target applications which are robotic vacuum app. 509, smart lock app. 508, and e-mail app. 507. Furthermore, the historical analysis of previous user inputs and target application identifies that in the past, the e-mail was sent to Emily@UXZ.com that is labeled 510 in FIG. 5. The user may select all of e-mail app. 507, smart lock app. 508, and robotic vacuum app. 509.

The analysis of the historical data and the contextual analysis of the user input and the retrieved previous user history leads application prediction program 120 determines that the instruction to smart lock app 508 should include an instruction to unlock the house at 3 pm. Similarly, the application prediction program 120 determines that the instruction to the robotic vacuum app. 509 should include an instruction to active the robotic vacuum at 3 pm. In another example, the user may only select e-mail app. 507 to Emily@UXZ.com from the displayed predicted applications.

FIG. 6 is a block diagram depicting components of a computer system 600 suitable for executing the incident containment program, in accordance with at least one embodiment of the invention. FIG. 6 displays the computer system 600, one or more processor(s) 604 (including one or more computer processors or central processor units), a communications fabric 602, a memory 606 including, a RAM 616, and a cache 618, a persistent storage 608, a communications unit 612, I/O interfaces 614, a display 622, and external devices 620. It should be appreciated that FIG. 6 provides only an illustration of one embodiment and does not imply any limitations with regard to the environments in which different embodiments may be implemented. Many modifications to the depicted environment may be made.

As depicted, the computer system 600 operates over the communications fabric 602, which provides communications between the computer processor(s) 604, memory 606, persistent storage 608, communications unit 612, and input/output (I/O) interface(s) 614. The communications fabric 602 may be implemented with an architecture suitable for passing data or control information between the processors 604 (e.g., microprocessors, communications processors, and network processors), the memory 606, the external devices 620, and any other hardware components within a system. For example, the communications fabric 602 may be implemented with one or more buses.

The memory 606 and persistent storage 608 are computer readable storage media. In the depicted embodiment, the memory 606 comprises a random-access memory (RAM) 616 and a cache 618. In general, the memory 606 may comprise any suitable volatile or non-volatile one or more computer readable storage media.

Program instructions for application prediction program 120 may be stored in the persistent storage 608, or more generally, any computer readable storage media, for execution by one or more of the respective computer processors 604 via one or more memories of the memory 606. In an embodiment, program instructions for application prediction program 120 may be stored in memory 606. The persistent storage 608 may be a magnetic hard disk drive, a solid-state disk drive, a semiconductor storage device, read only memory (ROM), electronically erasable programmable read-only memory (EEPROM), flash memory, or any other computer readable storage media that is capable of storing program instruction or digital information.

The media used by the persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of the persistent storage 608.

The communications unit 612, in these examples, provides for communications with other data processing systems or devices. In these examples, the communications unit 612 may comprise one or more network interface cards. The communications unit 612 may provide communications through the use of either or both physical and wireless communications links. In the context of some embodiments of the present invention, the source of the various input data may be physically remote to the computer system 600 such that the input data may be received, and the output similarly transmitted via the communications unit 612.

The I/O interface(s) 614 allow for input and output of data with other devices that may operate in conjunction with the computer system 600. For example, the I/O interface 614 may provide a connection to the external devices 620, which may be as a keyboard, keypad, a touch screen, or other suitable input devices. External devices 620 may also include portable computer readable storage media, for example thumb drives, portable optical or magnetic disks, and memory cards. Software and data used to practice embodiments of the present invention may be stored on such portable computer readable storage media and may be loaded onto the persistent storage 608 via the I/O interface(s) 614. The I/O interface(s) 614 may similarly connect to a display 622. The display 622 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adaptor card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, though the Internet using an Internet Service Provider). In some embodiments, electronic circuitry including, for example programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram blocks or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of computer program instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method, the computer-implemented method comprising:
receiving, by one or more computer processors, a user input to a computer user interface;
retrieving, by the one or more computer processors, a status of one or more connected computer devices;
performing, by the one or more computer processors, a contextual analysis of the user input;
retrieving, by the one or more computer processors, from a database, each of one or more previous target applications associated with at least one of previous user inputs similar to the user input;
predicting, by the one or more computer processors, at least one target application for the user input, based at least in part, on the database; and
displaying, by the one or more computer processors, the at least one target application for the user input to a user.

2. The computer-implemented method of claim 1, further comprising:
receiving, by the one or more computer processors, selection by the user of one or more of the at least one target application for the user input; and
retrieving, by the one or more computer processors, a user authorization for each of the one or more of the at least one target application for the user input selected by the user.

3. The computer-implemented method of claim 2, further comprising:
sending, by the one or more computer processors, the user input and the one or more of the at least one target application for the user input selected by the user to the database; and
creating, by the one or more computer processors, in the database, a knowledge-based corpus of a plurality of the user inputs and a plurality of the one or more of the at least one target application selected by the user for each user input of the plurality of the user inputs.

4. The computer-implemented method of claim 1, wherein retrieving, from the database, each of one or more previous target applications selected by the user associated with the at least one of the previous user inputs similar to the user input, further comprises:
retrieving, by the one of more computer processors, the contextual analysis of the user input;
determining, by the one or more computer processors, based at least in part, on the contextual analysis of the user input, the at least one similar user input in the database matching the user input;
determining, by the one or more computer processors, each of the one or more of the at least one target application selected by the user that are associated with the at least one of previous user inputs similar to the user input as at least one of the at least one target application for the user input; and
displaying, by the one or more computer processors, the at least one target application associated for the user input.

5. The computer-implemented method of claim 1, wherein retrieving the status of the one or more connected computer devices includes retrieving, by the one or more computer processors, an authorization to one or more of the at least one target application for the user input.

6. The computer-implemented method of claim 1, wherein predicting the at least one target application for the user input, based at least in part, on the database, further comprises:
determining, by the one or more computer processors, a user's level of authorization for access to each of the at least one target application: and
providing, by the one or more computer processors, authorization credentials associated with each of the at least one target application for the user input that the user's level of authorization provides the user access to.

7. The computer-implemented method of claim 6, further comprising displaying, by the one or more computer processors, each of the at least one target application for the user input that the user's level of authorization provides the user access to.

8. The computer-implemented method of claim 7, wherein displaying each of the at least one target application for the user input that the user's level of authorization provides the user access to includes preventing, by the one or more computer processors, the display of each of the at least one target application for the user input that the user does not have access to.

9. A computer program product comprising:
one or more computer readable storage media and program instructions stored on the one or more computer readable storage media, the program instructions executable by a processor, the program instructions comprising instructions for:
receiving, by one or more computer processors, a user input to a computer user interface;
retrieving, by the one or more computer processors, a status of one or more connected computer devices;
performing, by the one or more computer processors, a contextual analysis of the user input;
retrieving, by the one or more computer processors, from a database, each of one or more previous target applications associated with at least one of previous user inputs similar to the user input;
predicting, by the one or more computer processors, at least one target application for the user input, based at least in part, on the database; and
displaying, by the one or more computer processors, the at least one target application for the user input to a user.

10. The computer program product of claim 9, further comprising:
receiving, by the one or more computer processors, selection by the user of one or more of the at least one target application for the user input; and
retrieving, by the one or more computer processors, a user authorization for each of the one or more of the at least one target application for the user input selected by the user.

11. The computer program product of claim 10, further comprising:
sending, by the one or more computer processors, the user input and the one or more of the at least one target application for the user input selected by the user to the database; and
creating, by the one or more computer processors, in the database, a knowledge-based corpus of a plurality of the user inputs and a plurality of the one or more of the at least one target application selected by the user for each user input of the plurality of the user inputs.

12. The computer program product of claim 9, wherein retrieving, from the database, each of one or more previous target applications selected by the user associated with the at least one of the previous user inputs similar to the user input, further comprises:
retrieving, by the one of more computer processors, the contextual analysis of the user input;
determining, by the one or more computer processors, based at least in part, on the contextual analysis of the user input, the at least one similar user input in the database matching the user input;
determining, by the one or more computer processors, each of the one or more of the at least one target application selected by the user that are associated with the at least one of previous user inputs similar to the user input as at least one of the at least one target application for the user input; and
displaying, by the one or more computer processors, the at least one target application associated for the user input.

13. The computer program product of claim 9, wherein retrieving the status of the one or more connected computer devices includes retrieving, by the one or more computer processors, an authorization to one or more of the at least one target application for the user input.

14. The computer program product of claim 9, wherein predicting the at least one target application for the user input, based at least in part, on the database, further comprises:
determining, by the one or more computer processors, a user's level of authorization for access to each of the at least one target application: and
providing, by the one or more computer processors, authorization credentials associated with each of the at least one target application for the user input that the user's level of authorization provides the user access to.

15. The computer program product of claim 14, further comprising displaying, by the one or more computer processors, each of the at least one target application for the user input that the user's level of authorization provides the user access to.

16. A computer system comprising:
one or more computer processors;
one or more computer readable storage media;
program instructions stored on the one or more computer readable storage media for execution by at least one of the one or more processors, the program instructions comprising instructions to perform:
receiving, by the one or more computer processors, a user input to a computer user interface;
retrieving, by the one or more computer processors, a status of one or more connected computer devices;
performing, by the one or more computer processors, a contextual analysis of the user input;
retrieving, by the one or more computer processors, from a database, each of one or more previous target applications associated with at least one of previous user inputs similar to the user input;
predicting, by the one or more computer processors, at least one target application for the user input, based at least in part, on the database; and
displaying, by the one or more computer processors, the at least one target application for the user input to a user.

17. The computer system of claim 16, further comprising:
receiving, by the one or more computer processors, selection by the user of one or more of the at least one target application for the user input; and
retrieving, by the one or more computer processors, a user authorization for each of the one or more of the at least one target application for the user input selected by the user.

18. The computer system of claim 17, further comprising:
sending, by the one or more computer processors, the user input and the one or more of the at least one target application for the user input selected by the user to the database; and
creating, by the one or more computer processors, in the database, a knowledge-based corpus of a plurality of the user inputs and a plurality of the one or more of the at least one target application selected by the user for each user input of the plurality of the user inputs.

19. The computer system of claim 16, wherein retrieving, from the database, each of one or more previous target applications selected by the user associated with the at least one of the previous user inputs similar to the user input, further comprises:
retrieving, by the one of more computer processors, the contextual analysis of the user input;
determining, by the one or more computer processors, based at least in part, on the contextual analysis of the user input, the at least one similar user input in the database matching the user input;
determining, by the one or more computer processors, each of the one or more of the at least one target application selected by the user that are associated with the at least one of previous user inputs similar to the user input as at least one of the at least one target application for the user input; and
displaying, by the one or more computer processors, the at least one target application associated for the user input.

20. The computer system of claim 16, wherein retrieving the status of the one or more connected computer devices includes retrieving, by the one or more computer processors, an authorization to one or more of the at least one target application for the user input.
